(19) United States
(12) Patent Application Publication
(10) Pub. No.: US 2024/0184284 A1
(43) Pub. Date: Jun. 6, 2024

(54) INFORMATION PROCESSING DEVICE AND INFORMATION PROCESSING METHOD

(71) Applicant: Panasonic Intellectual Property Management Co., Ltd., Osaka (JP)

(72) Inventors: Kazuhiko NAKAGAWA, Hyogo (JP); Yukinori SASAKI, Hyogo (JP); Koji MIURA, Osaka (JP); Hironori OHIGASHI, Osaka (JP)

(21) Appl. No.: 18/549,811

(22) PCT Filed: Mar. 15, 2022
(86) PCT No.: PCT/JP2022/011470

§ 371 Date: Sep. 8, 2023

(30) Foreign Application Priority Data
Mar. 16, 2021 (JP) 2021-042839

(51) Int. Cl. G05B 23/02

(52) U.S. Cl. CPC G05B 23/0283

(57) ABSTRACT

An information processing device includes: a quality evaluator that evaluates the quality of a plurality of instances of first data to generate a first evaluation result and evaluates the quality of a plurality of instances of second data to generate a second evaluation result; a learner that performs machine learning, using the plurality of instances of first data, to generate a machine learning model for detecting an anomaly; a detector that compares the first evaluation result and the second evaluation result and detects a concept drift, based on a comparison result; and an anomaly estimator that applies the machine learning model to the plurality of instances of second data to estimate whether an anomaly is present in the plurality of instances of second data.

### CROSS-REFERENCE OF RELATED APPLICATIONS

This application is the U.S. National Phase under 35 U.S.C. § 371 of International Patent Application No. PCT/JP2022/011470, filed on Mar. 15, 2022, which in turn claims the benefit of Japanese Patent Application No. 2021-042839, filed on Mar. 16, 2021, the entire disclosures of which Applications are incorporated by reference herein.

### TECHNICAL FIELD

The present disclosure relates to an information processing device and an information processing method.

### Background Art

A facility device is provided with a sensor that detects, for example, an operating state of the facility device. Learning is performed on sensor data outputted from the sensor to generate a machine learning model, thereby detecting an anomaly in the facility device.

With changes in the state of the facility device or the factory environment, for example, many of sensor data can be data representing different behaviors from the ones that are expected at the time of learning. In this case, the use of the trained machine learning model results in a failure to grasp the state of the facility device as expected. Consequently, it becomes impossible to accurately detect an anomaly. Stated differently, the machine learning model is not in an optimal state, that is, in a degraded state. A state where a machine learning model is degraded is referred to as “concept drift”.

When an anomaly is detected in the state where a concept drift has occurred, it is difficult to determine whether such anomaly is actually an anomaly of the facility device or an anomaly attributable to the concept drift (no anomaly is present in the facility device). In other words, the reliability of an anomaly detection system is degraded.

In view of the above, an appropriate detection of a concept drift is required. For example, patent literature (PTL) 1 discloses an anomaly detection device that detects a concept drift by evaluating the accuracy of the previous learning when re-learning is performed on a machine learning model.

### CITATION LIST

### Patent Literature

[PTL 1] Japanese Unexamined Patent Application Publication No. 2020-64367

### SUMMARY OF INVENTION

### Technical Problem

However, since the above conventional anomaly detection device needs to wait for the timing of re-learning, the real-timeliness of concept drift detection is low. Also, since a large amount of data is usually required for learning, an increased amount of computation is required for concept drift detection.

In view of the above, the present disclosure provides an information processing device and an information processing method that are capable of detecting a concept drift in a highly real-time manner with a small amount of computation.

### Solution to Problem

The information processing device according to an aspect of the present disclosure includes: an evaluator that evaluates quality of a plurality of instances of first data to generate a first evaluation result and evaluates quality of a plurality of instances of second data to generate a second evaluation result; a learner that performs machine learning, using the plurality of instances of first data, to generate a machine learning model for detecting an anomaly; a detector that compares the first evaluation result and the second evaluation result and detects a concept drift, based on a comparison result; and an estimator that applies the machine learning model to the plurality of instances of second data to estimate an anomaly in the plurality of instances of second data.

The information processing method according to an aspect of the present disclosure includes: evaluating quality of a plurality of instances of first data to generate a first evaluation result; performing machine learning, using the plurality of instances of first data, to generate a machine learning model for detecting an anomaly; evaluating quality of a plurality of instances of second data to generate a second evaluation result; comparing the first evaluation result and the second evaluation result and detecting a concept drift, based on a comparison result; and applying the machine learning model to the plurality of instances of second data to estimate whether an anomaly is present in the plurality of instances of second data.

An aspect of the present disclosure can also be implemented as a program that causes a computer to execute the foregoing information processing method. Alternatively, an aspect of the present disclosure can be implemented as a non-transitory computer readable recording medium having recorded thereon such program.

### Advantageous Effects of Invention

According to the present disclosure, it is possible to detect a concept drift in a highly real-time manner with a small amount of computation.

### BRIEF DESCRIPTION OF DRAWINGS

FIG. 1 is a diagram showing the configuration of an information processing device according to an embodiment.

FIG. 2 is a diagram showing data types of lot data that is an example of an input dataset.

FIG. 3 is a diagram showing an overview of processing performed by the information processing device according to the embodiment.

FIG. 4 is a diagram showing data that has undergone pre-processing.

FIG. 5A is a diagram showing a basic profile used for data quality evaluation.

FIG. 5B is a diagram showing a statistics profile used for data quality evaluation.

FIG. 5C is a diagram showing a machine learning profile used for data quality evaluation.

FIG. 6 is a diagram showing a machine learning model generated through machine learning.

FIG. 7 is a flowchart of processing performed in a learning phase among the processes performed by the information processing device according to the embodiment.

FIG. 8 is a flowchart of pre-processing among the processes performed by the information processing device according to the embodiment.

FIG. 9 is a flowchart of a data quality evaluation performed in the learning phase among the processes performed by the information processing device according to the embodiment.

FIG. 10A is a diagram showing check results that are based on the basic profile and obtained for the respective records and evaluation items.

FIG. 10B is a diagram showing quality evaluation results that are based on the basic profile.

FIG. 11 is a flowchart of processing performed in an operation phase among the processes performed by the information processing device according to the embodiment.

FIG. 12 is a flowchart of a variation of the processing performed in the operation phase among the processes performed by the information processing device according to the embodiment.

FIG. 13 is a flowchart of a data quality evaluation performed in the operation phase among the processes performed by the information processing device according to the embodiment.

FIG. 14 is a diagram showing a detection recipe for concept drift detection.

FIG. 15A is a diagram showing recipes of the respective data items in the detection recipe for concept drift detection.

FIG. 15B is a diagram showing a recipe of concept drift determination in the detection recipe for concept drift detection.

FIG. 15C is a diagram showing a recipe for concept drift notification.

FIG. 16 is a diagram showing rules for events that can occur in a factory.

FIG. 17 is a diagram showing sensor data and its statistics.

FIG. 18 is a block diagram showing the configuration of a notifier and an UI in the information processing device according to the embodiment.

FIG. 19 is a diagram showing a data analysis UI.

FIG. 20 is a diagram showing an outline check UI.

FIG. 21 is a diagram showing a detail check UI.

### DESCRIPTION OF EMBODIMENT

### Summary of the Present Disclosure

The information processing device according to an aspect of the present disclosure includes: an evaluator that evaluates quality of a plurality of instances of first data to generate a first evaluation result and evaluates quality of a plurality of instances of second data to generate a second evaluation result; a learner that performs machine learning, using the plurality of instances of first data, to generate a machine learning model for detecting an anomaly; a detector that compares the first evaluation result and the second evaluation result and detects a concept drift, based on a comparison result; and an estimator that applies the machine learning model to the plurality of instances of second data to estimate an anomaly in the plurality of instances of second data.

As described above, a concept drift is detected on the basis of the quality evaluation result on each of the plurality of instances of second data that are subjected to anomaly estimation. Stated differently, it is possible to promptly detect a concept drift at the timing of performing anomaly estimation, without needing to wait for the timing of re-learning. Also, the quality evaluation results are simply required to be compared to detect a concept drift. This means that the processing of an enormous amount data is not necessary as is done in re-learning. This results in a reduced amount of computation required for concept drift detection. As described above, the information processing device according to the present aspect is capable of detecting a concept drift in a highly real-time manner with a small amount of computation.

Also, for example, the evaluator may include a basic evaluator that evaluates each of the plurality of instances of first data and each of the plurality of instances of second data, based on a first profile whose evaluation item is at least one of a data type, a character code, or an anomalous value, the first evaluation result may include an evaluation result on each of the plurality of instances of first data, the evaluation result being based on the first profile, and the second evaluation result may include an evaluation result on each of the plurality of instances of second data, the evaluation result being based on the first profile.

With this, it is possible to evaluate the basic properties of the data, as a result of which the reliability of the comparison result on the evaluation results also increases. This increases the accuracy of concept drift detection that is based on the comparison result.

Also, for example, the evaluator may include a statistics evaluator that evaluates statistics of the plurality of instances of first data and statistics of the plurality of instances of second data, based on a second profile whose evaluation item is at least one statistic, the first evaluation result may include an evaluation result on each of the plurality of instances of first data, the evaluation result being based on the second profile, and the second evaluation result may include an evaluation result on each of the plurality of instances of second data, the evaluation result being based on the second profile.

With this, it is possible to evaluate the statistics of the data, as a result of which the reliability of the comparison result on the evaluation results also increases. This increases the accuracy of concept drift detection that is based on the comparison result. Also, for example, the evaluator may include a learning evaluator that evaluates the plurality of instances of second data, based on a third profile whose evaluation item is at least one feature in the machine learning, and the second evaluation result may include an evaluation result on each of the plurality of instances of second data, the evaluation result being based on the third profile.

With this, it is possible to evaluate the features in machine learning, as a result of which the reliability of the comparison result on the evaluation results also increases. This increases the accuracy of concept drift detection that is based on the comparison result.

Also, for example, the information processing device according to an aspect of the present disclosure may further include an obtainer that obtains a plurality of instances of data; and a pre-processor that performs pre-processing on the plurality of instances of data to generate the plurality of instances of first data and the plurality of instances of second data.

With this, by performing the pre-processing, it becomes easy to perform the processes of machine learning and data quality evaluation.

Also, for example, the pre-processing may include data cleansing and at least one of data coupling or data conversion.

With this, by performing the pre-processing in stages, it is also possible to utilize the result of data cleansing performed in the second stage for data quality evaluation. This increases the reliability of the comparison result on the evaluation results, thereby increasing the accuracy of concept drift detection that is based on the comparison result.

Also, for example, the information processing device according to an aspect of the present disclosure may further include a notifier that provides a notification indicating that a concept drift has been detected, when the detector detects the concept drift.

With this, by providing a notification about the occurrence of a concept drift to a manager or a worker of the equipment, or a system manager, for example, it is possible to support a correct determination on the anomaly estimation result. Consequently, the manager, etc.

is able to promptly cope with the occurrence of the concept drift and an anomaly. This contributes to, for example, an improvement in production efficiency.

Also, for example, when the detector detects a concept drift, the learner may perform machine learning, using a plurality of instances of data that are different from the plurality of instances of first data, to generate the machine learning model anew.

With this, it is possible to promptly perform re-learning when a concept drift occurs and the reliability of the anomaly estimation result is degraded. This increases the reliability of the anomaly estimation result.

Also, the information processing method according to an aspect of the present disclosure includes: evaluating quality of a plurality of instances of first data to generate a first evaluation result; performing machine learning, using the plurality of instances of first data, to generate a machine learning model for detecting an anomaly; evaluating quality of a plurality of instances of second data to generate a second evaluation result; comparing the first evaluation result and the second evaluation result and detecting a concept drift, based on a comparison result; and applying the machine learning model to the plurality of instances of second data to estimate whether an anomaly is present in the plurality of instances of second data.

With this, it is possible to detect a concept drift in a highly real-time manner with a small amount of computation as with the foregoing information processing device according to an aspect.

Also, the program according to an aspect of the present disclosure is a program that causes a computer to execute the foregoing information processing method according to an aspect.

With this, it is possible to detect a concept drift in a highly real-time manner with a small amount of computation as with the foregoing information processing device according to an aspect.

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the appended Claims and their equivalents. Therefore, among the elements in the following exemplary embodiment, those not recited in any one of the independent claims are described as optional elements.

The drawings are schematic views and thus are not always strictly drawn. As such, for example, the drawings are not always drawn to scale. In the drawings, the same referential numerals are given to substantially the same configurations, and duplication of descriptions of the substantially the same configurations will be omitted or simplified.

### Embodiment

### 1. Overview

The following describes an overview of the information processing device according to an embodiment.

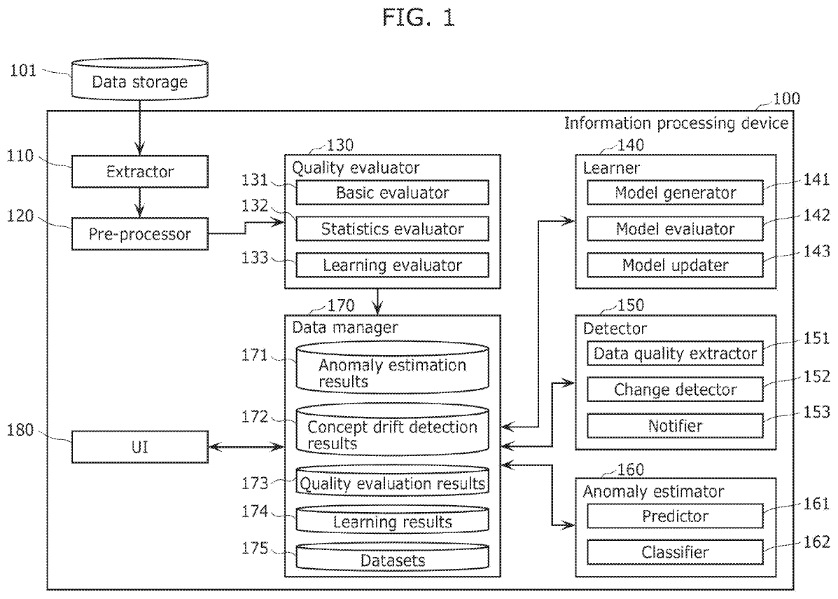

FIG. 1 is a diagram showing the configuration of information processing device 100 according to the present embodiment. Information processing device 100 shown in FIG. 1 is a device that performs machine learning to estimate an anomaly in an input dataset.

The input dataset includes a plurality of instances of data and is stored in data storage 101. The input dataset is, for example, lot data relating to the manufacture of a lot that is a unit of product manufacture.

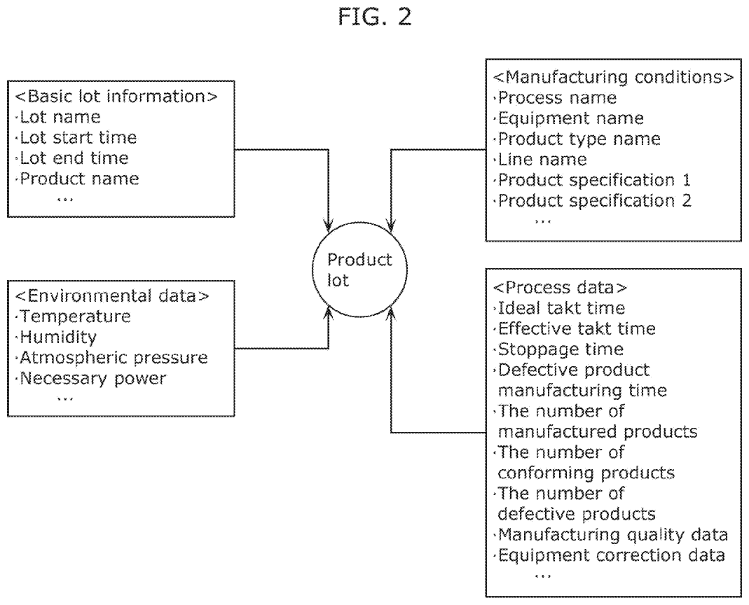

FIG. 2 is a diagram showing the data types of the lot data that is an example of the input dataset. The lot data shown in FIG. 2 includes: data items relating to the manufacture of the lot that is a unit of product manufacture; and the values of each of the data items.

As shown in FIG. 2, the data items are roughly divided into four items: basic lot information; environmental data; manufacturing conditions; and process data. The basic lot information includes the lot name of a target lot, the lot start time, the lot end time, the product name, and so forth. The environmental data includes the temperature, the humidity, the atmospheric pressure, necessary power, and so forth at the time of manufacturing the target lot. The manufacturing conditions include the process name of the target lot, the equipment name, the product type name, the line name, the product specifications, and so forth. The process data includes the ideal takt time, the effective takt time, the stoppage time, the defective product manufacturing time, the number of manufactured products, the number of conforming products, the number of defective products, the manufacturing quality data, the equipment correction data, and so forth of the target lot.

The values of each data item are, for example, sensor data obtained by sensors located in the manufacturing equipment, the manufacturing line, or inside of the factory, input data inputted by a manufacturing manager, or data that is generated on the basis of these instances of data. Stated differently, a plurality of instances of data included in the input dataset include, for example, a plurality of instances of sensor data outputted from a plurality of sensors that detect the operation states of the manufacturing equipment. Sensor data is time series data that represents changes over time in sensor output.

For example, data indicated in the manufacturing conditions is used as a feature in machine learning. The process data includes data used as explanatory variables in machine learning and data used as an objective variable in machine learning. For example, the number of manufactured products, the number of conforming products, and the number of defective products are used as explanatory variables, and the ideal takt time is used as an objective variable. Also, each data of the environmental data and the process data is used for the calculation of the statistics of each data item. Note that which data to use in what manner is preliminarily determined or can be set by, for example, the manager of information processing device 100 as appropriate.

Information processing device 100 according to the present embodiment estimates an anomaly in the lot data, thereby estimating an anomaly in the manufacturing equipment. An anomaly refers to, for example, a trouble or a failure of the manufacturing equipment, that is, a state where the production efficiency of products (conforming products) is degraded.

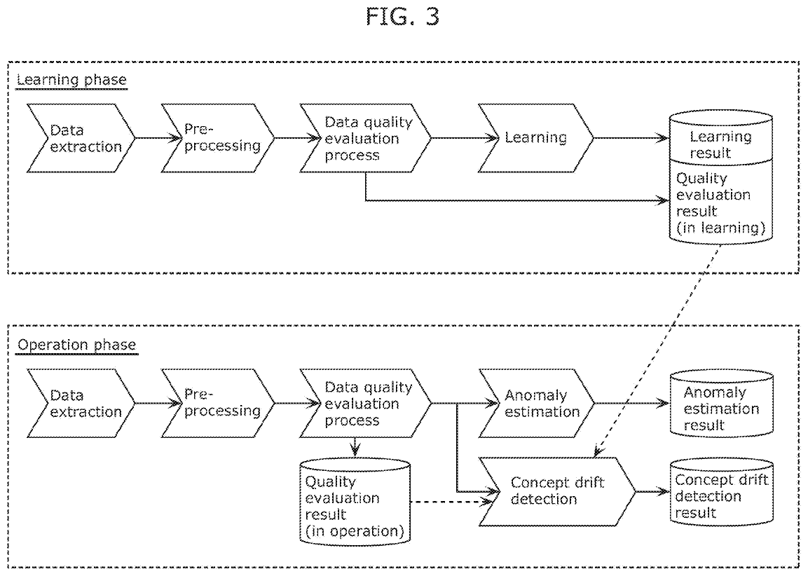

FIG. 3 is a diagram showing an overview of the processing performed by information processing device 100 according to the present embodiment. As shown in FIG. 3, the processing performed by information processing device 100 can be divided into a learning phase and an operation phase. In the learning phase, information processing device 100 performs machine learning, using a dataset for learning, thereby generating and storing a learning result. The learning result includes, for example, a machine learning model for detecting an anomaly. In the operation phase, information processing device 100 applies the machine learning model generated in the learning phase to a dataset to be subjected to anomaly detection, thereby estimating an anomaly.

Information processing device 100 evaluates the quality of the dataset in each of the learning phase and the operation phase. Information processing device 100 compares the quality evaluation result in the learning phase and the quality evaluation result in the operation phase, and detects a concept drift on the basis of the comparison result.

A concept drift refers to a state where the statistical properties of an objective variable that the machine learning model is trying to predict change over time in an unexpected manner. In the present embodiment, “concept drift” also refers to a state where the machine learning model should not be applied to a target dataset in the operation phase due to such change. Stated differently, “that a concept drift has been detected” means that the machine learning model is no longer in an optimal state.

With information processing device 100 according to the present embodiment, a concept drift is detected, using the comparison result on the quality evaluations in the operation phase. As such, it is not necessary to wait for the timing of re-learning, and thus concept drift detection is performed in highly real-time. Also, the use of the comparison result on the quality evaluations eliminates the necessity to process a large amount of data as is done in re-learning and thus results in a smaller amount of computation required for concept drift detection.

A state where no concept drift is detected is a state where the machine learning model is optimal, meaning that the reliability of an anomaly estimation result is also high. Meanwhile, a state where a concept drift is detected is not a state where the machine learning model is optimal, meaning that the reliability of an anomaly estimation result is also low. As described above, by detecting a concept drift, it is possible to determine whether an anomaly estimation result is reliable.

Also, when a concept drift is detected, it is possible to update the machine learning model to an optimal state through re-learning. Stated differently, by performing re-learning in response to the detection of a concept drift, it is possible to effectively perform re-learning at a necessary timing, without performing unrequired re-learning.

### 2. Configuration

The following describes a specific configuration of information processing device 100 according to the present embodiment.

Information processing device 100 is a computer device that performs the information processing method according to the present embodiment. Information processing device 100 may be a single computer device or a plurality of computer devices that are connected via a network. Information processing device 100 includes, for example, a nonvolatile memory that stores a program, a volatile memory that is a temporary storage region used to execute the program, an input-output port, a processor that executes the program, and so forth. The processor executes the processes of the functional processing units included in information processing device 100 in conjunction with, for example, the memories.

Information processing device 100 reads out necessary datasets from data storage 101 and performs processing, using the datasets read out. In the present embodiment, data storage 101 is a storage device that is provided separately from information processing device 100. Data storage 101 is connected to information processing device 100 by wire or wirelessly to be able to communicate with information processing device 100. Data storage 101 is, for example, a hard disk drive (HDD) or a solid state drive (SDD). Note that information processing device 100 may include data storage 101.

As shown in FIG. 1, information processing device 100 includes extractor 110, pre-processor 120, quality evaluator 130, learner 140, detector 150, anomaly estimator 160, data manager 170, and user interface (UI) 180.

Extractor 110 is an example of the obtainer that obtains a plurality of instances of data. Extractor 110 extracts a plurality of instances of data from data storage 101. More specifically, extractor 110 extracts a dataset for learning in the learning phase and extracts a dataset to be subjected to anomaly estimation in the operation phase.

Pre-processor 120 performs pre-processing on a plurality of instances of data. Pre-processor 120 performs the pre-processing in both the learning phase and the operation phase. The pre-processing is processing for organizing data formats for performing machine learning or for applying data to a machine learning model. The pre-processing will be specifically described in detail later.

Pre-processor 120 performs the pre-processing on the dataset for learning extracted by extractor 110, thereby generating a plurality of instances of learning data. Each learning data is an example of the first data, which is, for example, sensor data.

Pre-processor 120 also performs the pre-processing on the dataset to be subjected to anomaly estimation extracted by extractor 110, thereby generating a plurality of instances of operation data. Each operation data is an example of the second data, which is, for example, sensor data. Operation data is data not used for learning in machine learning. Note that operation data can be future learning data, that is, learning data to be used for re-learning.

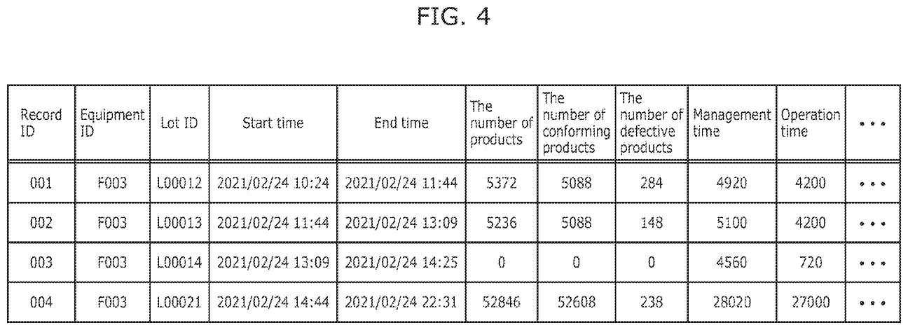

FIG. 4 is a diagram showing data that has undergone the pre-processing. The data that has undergone the pre-processing is learning data or operation data, and includes a plurality of records. Each of the records includes the values of the respective data items. Both the learning data and the operation data can be represented in tabular form as shown in FIG. 4. Note that FIG. 4 shows an example in which a single record is generated for each lot, but the present disclosure is not limited to this example.

Quality evaluator 130 evaluates the quality of a plurality of instances of learning data, thereby generating an evaluation result in the learning phase. The evaluation result in the learning phase is an example of the first evaluation result. Quality evaluator 130 also evaluates the quality of a plurality of instances of operation data, thereby generating an evaluation result in the operation phase. The evaluation result in the operation phase is an example of the second evaluation result.

In the present embodiment, quality evaluator 130 evaluates learning data and operation data, on the basis of three profiles. Each of the profiles is information indicating evaluation items to be evaluated in data quality evaluation, and the appropriate value or the appropriate range of each of the evaluation items. The profiles are stored, for example, in a memory included in quality evaluator 130 or data manager 170. More specifically, the three profiles are a basic profile, a statistics profile, and a machine learning profile.

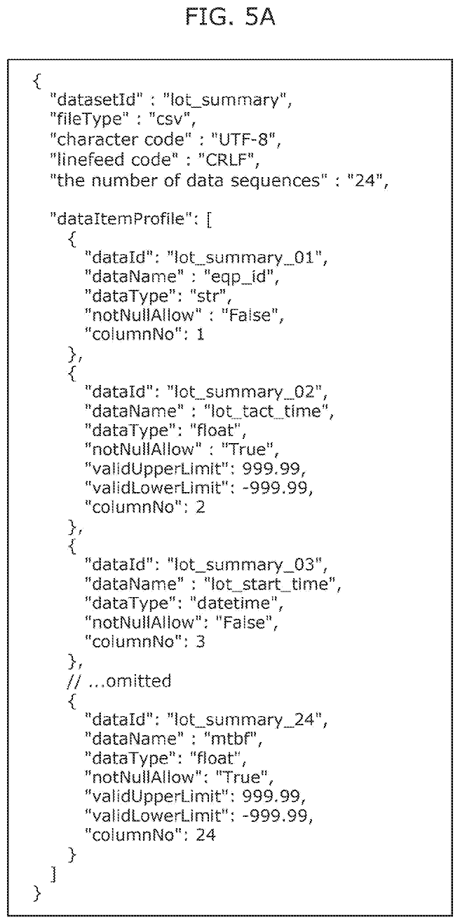

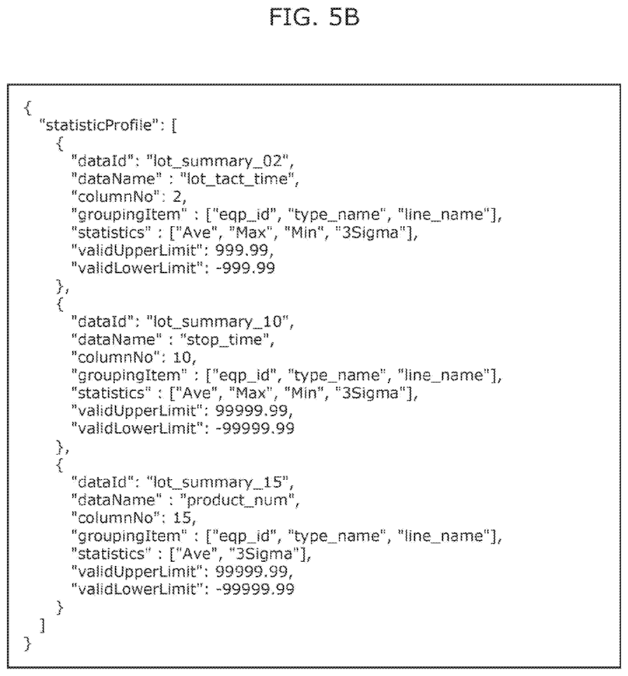

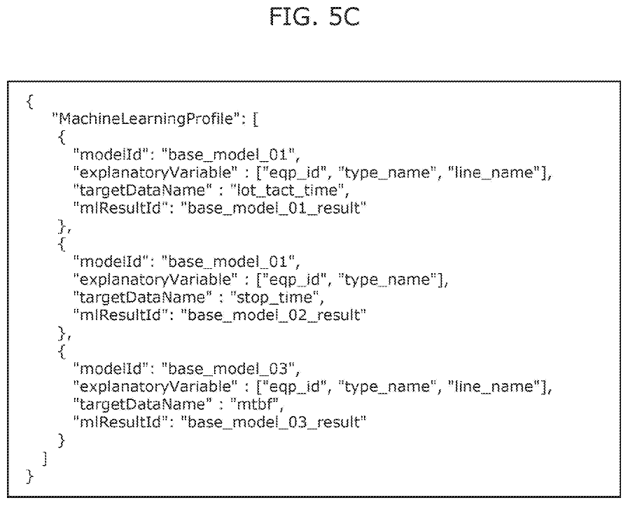

FIG. 5A is a diagram showing the basic profile used for data quality evaluation. The basic profile is an example of the first profile whose evaluation item is at least one of data type, character code, or anomalous value (noise). The basic profile shown in FIG. 5A includes the evaluation items for the whole dataset and the evaluation items for each data. The evaluation items for the whole dataset include, for example, the file type (data format) of the dataset, the character code, the linefeed code, and/or the number of data items for each record, etc. The evaluation items for each data include, for example, the type of each data item, whether to allow NULL, and/or whether the data is within the valid range (i.e., whether the data is an anomalous value). The valid range is defined by the upper limit value and the lower limit value.

FIG. 5B is a diagram showing the statistics profile used for the data quality evaluation. The statistics profile is an example of the second profile whose evaluation item is at least one statistic. The statistics profile shown in FIG. 5B includes, as example statistics, the average value, the maximum value, the minimum value, and 3σ (σ is the standard deviation) of a certain data item. The statistics profile defines data items to be subjected to statistics calculation and grouping items.

FIG. 5C is a diagram showing the machine learning profile used for data quality evaluation. The machine learning profile is an example of the third profile whose evaluation item is at least one feature in machine learning. The machine learning profile shown in FIG. 5C defines, on a model-by-model basis, a data item of explanatory variable (feature) used to check whether the features are learned features and whether the features are within the range of learning statistics. The machine learning profile also defines a reference to a learning result used to check whether features are within the range of the learning statistics. Stated differently, the machine learning profile shows the items whose quality is to be evaluated on the basis of the result of machine learning and the appropriate value or the appropriate range of such items.

Note that the number and types of evaluation items included in each profile shown in FIG. 5A through FIG. 5C are mere examples, and thus the present disclosure is not limited to these examples shown in these diagrams.

As shown in FIG. 1, quality evaluator 130 includes basic evaluator 131, statistics evaluator 132, and learning evaluator 133. Basic evaluator 131 evaluates a plurality of instances of learning data and a plurality of instances of operation data, on the basis of the basic profile shown in FIG. 5A. Statistics evaluator 132 evaluates a plurality of instances of learning data and a plurality of instances of operation data, on the basis of the statistics profile shown in FIG. 5B. Learning evaluator 133 evaluates a plurality of instances of operation data, on the basis of the machine learning profile shown in FIG. 5C. Note that the machine learning profile is generated as a result of performing the learning phase. As such, learning evaluator 133 does not use the machine learning profile for the evaluation of learning data.

Learner 140 performs machine learning, using a plurality of instances of learning data, thereby generating a machine learning model for detecting an anomaly. As shown in FIG. 1, learner 140 includes model generator 141, model evaluator 142, and model updater 143.

Model generator 141 performs machine learning, using a plurality of instances of learning data, thereby generating a machine learning model. Machine learning is performed, for example, through Bayesian estimation. A machine learning model is defined, for example, by the distribution type of an objective variable (e.g., effective takt time) and at least one parameter of such distribution. When the distribution is a normal distribution, for example, at least one parameter includes, for example, the mean value and the variance. The distribution may also be, for example, a logarithmic exponential distribution, a zero-inflated exponential distribution, a normal exponential distribution, or a gamma distribution.

Note that machine learning is not limited to a specific method. Example methods of supervised learning include a method utilizing classifier, a method utilizing incremental support vector machine, an incremental decision tree method, an incremental deep convolutional neural network method, etc.

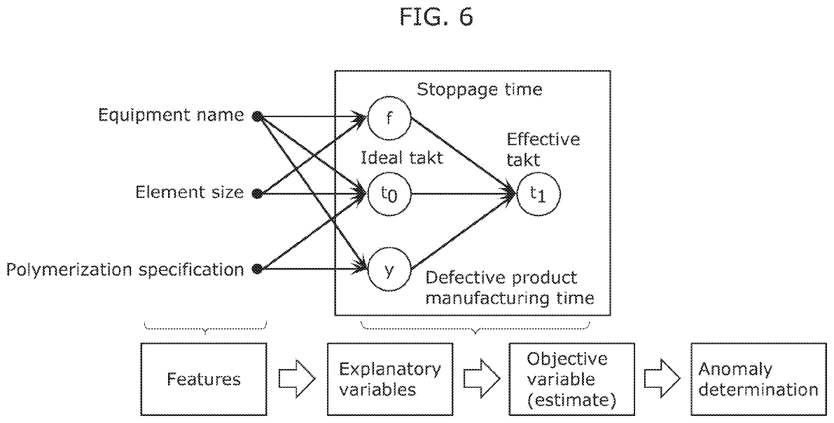

FIG. 6 is a diagram showing a machine learning model generated through machine learning. The machine learning model shown in FIG. 6 uses stoppage time f, ideal takt time t₀, and defective product manufacturing time y as explanatory variables and uses effective takt time t₁ as an objective variable. The three explanatory variables are determined on the basis of a plurality of features. Here, an example is shown in which the features are the name of equipment used for the manufacture, the element size that is the product size, and polymerization specification that is one of the product specifications, but the present disclosure is not limited to these. Features are selected, for example, from a plurality of data items shown in FIG. 2.

Model evaluator 142 evaluates the generated machine learning model. More specifically, model evaluator 142 evaluates the machine learning model, thereby determining whether the machine learning model needs to be updated. For example, model evaluator 142 evaluates the reliability of an anomaly estimation result, on the basis of the difference between the estimation result on an anomaly that is estimated on the basis of the machine learning model and an anomaly that actually occurs. Model evaluator 142 determines that the accuracy of the machine learning model is higher as the anomaly estimation result is more correct. When the accuracy of the machine learning model has become low, model evaluator 142 determines that the machine learning model needs to be updated.

Model updater 143 updates the machine learning model. More specifically, when detector 150 detects a concept drift, model updater 143 generates a new machine learning model by performing machine learning, using a plurality of instances of data (i.e., new learning data) that are different from the learning data used to generate the machine learning model before being updated (i.e., previous learning data). The new learning data includes, for example, the operation data used when the concept drift is detected. The new learning data may include at least part of the previous learning data.

Detector 150 compares the quality evaluation result in the learning phase and the quality evaluation result in the operation phase and detects a concept drift, on the basis of the comparison result. As shown in FIG. 1, detector 150 includes data quality extractor 151, change detector 152, and notifier 153.

Data quality extractor 151 extracts quality evaluation results 173 managed by data manager 170. Change detector 152 detects a change in data quality. More specifically, change detector 152 compares the quality evaluation result in the learning phase and the quality evaluation result in the operation phase. For example, change detector 152 determines whether the quality evaluation result in the operation phase falls within the appropriate range that is defined on the basis of the quality evaluation result in the learning phase. When the quality evaluation result in the operation phase does not fall within the appropriate range, that is, when a significant difference is present in the quality evaluation results between the operation phase and the learning phase, change detector 152 determines that a concept drift has been detected. Note that the appropriate range may be the quality evaluation result per se in the learning phase or may be a predetermined range that can be regarded as substantially the same as the quality evaluation result in the learning phase.

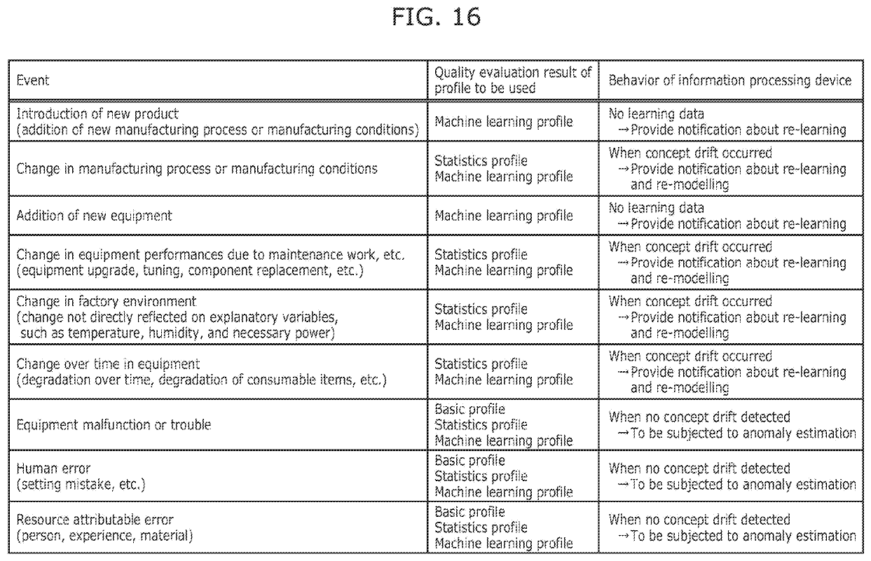

Also, which ones of the plurality of evaluation items to compare and the number of such evaluation items are determined, for example, on the basis of a predetermined rule. A rule is defined, for example, for each event that can occur in the manufacturing site, such as a factory. Specific examples of events and the relation between the events and the profiles will be described later with reference to FIG. 16.

When a concept drift is detected, notifier 153 provides a notification indicating that a concept drift has been detected. For example, notifier 153 provides a notification indicating that a concept drift has been detected to a preliminarily registered terminal, etc., using a function such as an e-mail and/or short message function. A specific configuration of notifier 153 and the details of the processing performed by notifier 153 will be described later.

Anomaly estimator 160 applies the machine learning model to a plurality of instances of operation data, thereby estimating whether an anomaly is present in the plurality of instances of operation data. As shown in FIG. 1, anomaly estimator 160 includes predictor 161 and classifier 162.

Predictor 161 predicts an objective variable on the basis of the plurality of instances of operation data and the machine learning model. More specifically, predictor 161 applies the machine learning model to the plurality of instances of operation data, thereby calculating an estimate of the objective variable. In an example shown in FIG. 6, the estimate of the objective variable is an estimate of the effective takt time.

Classifier 162 classifies an actual measured value into an anomalous value or a normal value, on the basis of the prediction result (i.e., estimate) obtained by predictor 161. More specifically, classifier 162 calculates, as an anomaly level, the difference degree that indicates the degree at which the actual measured value of the effective takt time included in the operation data differs from the estimate of the effective takt time. The greater the difference degree, the more anomalous the actual measured value. For example, classifier 162 compares the calculated difference degree with a threshold and determines that the operation data is anomalous when the difference degree is greater than the threshold. Classifier 162 determines that operation data is normal when the difference degree is smaller than the threshold. Note that the classification of operation data into an anomalous value or a normal value is not limited to the foregoing method.

Data manager 170 holds, for example, data required for the processing performed by information processing device 100 according to the present embodiment and data obtained by information processing device 100 performing the processing. For example, as shown in FIG. 1, data manager 170 stores and manages anomaly estimation results 171, concept drift detection results 172, quality evaluation results 173, learning results 174, and datasets 175.

Anomaly estimation results 171 are data indicating the results estimated by anomaly estimator 160.

Concept drift detection results 172 are data indicating the concept drift detection results obtained by detector 150. Quality evaluation results 173 are the evaluation results, obtained by quality evaluator 130, on the data quality of each learning data and each operation data.

Learning results 174 are data indicating the learning results obtained by learner 140. More specifically, learning results 174 include, for example, parameters of a machine learning model.

Datasets 175 are datasets which are extracted by extractor 110 and on which the pre-processing has been performed by pre-processor 120. Stated differently, datasets 175 include learning data and operation data.

Data manager 170 manages the quality evaluation result in the learning phase and learning result 174 in association with each other. Stated differently, the quality evaluation result and learning result 174 that are generated using the same learning data are associated with each other. Data manager 170 also manages the quality evaluation result in the operation phase, anomaly estimation result 171, and concept drift detection result 172 in association with one another. Stated differently, the quality evaluation result, anomaly estimation result 171, and concept drift detection result 172 that are generated using the same operation data are associated with one another.

UI 180 generates and manages a user interface. More specifically, UI 180 generates a graphical user interface (GUI). The GUI includes a text and an image, and a display screen (window) that includes a button or an icon that is operatable or selectable by a user. UI 180 causes the display to display the display screen, receives an operation input from the user, and performs processing that corresponds to the received operation input. Note that the user is, for example, the manager of information processing device 100 or the manufacturing manager. A specific example of the GUI will be described later. The display is a display device that is different from information processing device 100, but may be a display included in information processing device 100.

### 3. Operation

The following describes an operation performed by information processing device 100 according to the present embodiment.

### 3-1. Learning Phase

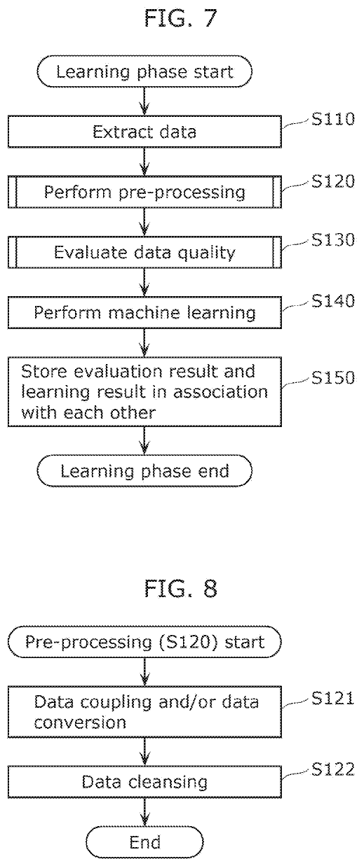

With reference to FIG. 7, the following describes processing performed in the learning phase. FIG. 7 is a flowchart of the processing performed in the learning phase among the processes performed by information processing device 100 according to the present embodiment. The learning phase starts upon receipt of a start instruction from, for example, the manager, or at regular time intervals. Alternatively, the learning phase may start in response to the detection of a concept drift.

In the learning phase, as shown in FIG. 7, extractor 110 first extracts a dataset for learning (S110). Extractor 110 extracts, as the dataset for learning, a plurality of instances of sensor data for a predetermined period, such as one week and one month, from data storage 101.

Next, pre-processor 120 performs the pre-processing on the extracted dataset for learning (S120). Data manager 170 stores and manages, in the memory, a plurality of instances of learning data that are instances of data having undergone the pre-processing as dataset 175. A specific example of the pre-processing will be described later with reference to FIG. 8.

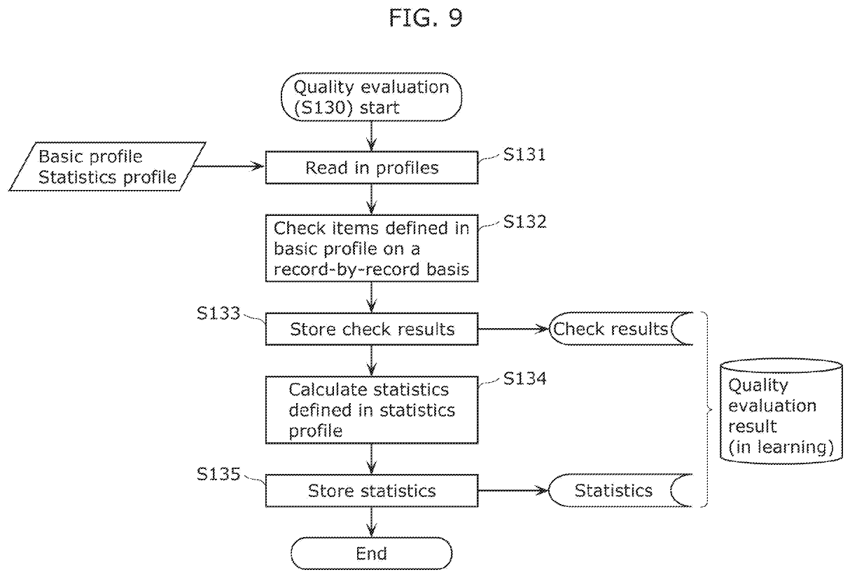

Next, quality evaluator 130 evaluates the quality of each learning data (S130). Data manager 170 stores and manages, in the memory, the quality evaluation result as part of quality evaluation results 173. A specific example of the quality evaluation on learning data will be described later with reference to FIG. 9.

Next, learner 140 performs machine learning, using the plurality of instances of learning data, thereby generating a machine learning model (S140). Data manager 170 stores and manages, in the memory, the generated machine learning model as learning result 174 in association with quality evaluation results 173 (S150).

As described above, in information processing device 100 according to the present embodiment, not only learning result 174 that is generated using a plurality of instances of learning data, but also the quality evaluation result on the plurality of instances of learning data are stored in the learning phase. Of these, the quality evaluation result is used for concept drift detection.

### 3-1-1. Pre-Processing

With reference to FIG. 8, the following describes a specific example of the pre-processing (S120) shown in FIG. 7. FIG. 8 is a flowchart of the pre-processing among the processes performed by information processing device 100 according to the present embodiment.

In the present embodiment, pre-processor 120 performs the pre-processing having stages. More specifically, pre-processor 120 performs the pre-processing in two stages.

To be more specific, as shown in FIG. 8, pre-processor 120 performs, as first-stage processing, at least one of data coupling or data conversion on the plurality of instances of sensor data extracted by extractor 110 (S121). Data coupling is performed, for example, to make uniform the time length of time series data. Data conversion is, for example, smoothing of the time series data. Note that the first-stage processing may include extraction of features such as statistics. Through the above processes, the instances of data that have undergone the first-stage processing can be represented in tabular form as shown in FIG. 4.

Next, pre-processor 120 performs data cleansing as second-stage processing (S122). Data cleansing includes the removal of an anomalous value (or anomalous record), the removal of a missing record, the complement of missing data, and so forth.

In the present embodiment, learning data is generated by performing the pre-processing in two stages as described above. Note that the processing performed as the pre-processing is not limited to the example described above. Also, the pre-processing may not be performed.

### 3-1-2. Quality Evaluation (Learning Phase)

With reference to FIG. 9, the following describes a quality evaluation performed on learning data. FIG. 9 is a flowchart of a data quality evaluation performed in the learning phase among the processes performed by information processing device 100 according to the present embodiment.

First, as shown in FIG. 9, quality evaluator 130 reads in the basic profile and the statistics profile (S131).

Next, basic evaluator 131 evaluates each learning data, on the basis of the basic profile (S132). More specifically, basic evaluator 131 evaluates the learning data for the items defined in the basic profile on a record-by-record basis.

For example, basic evaluator 131 determines whether the target data is the appropriate value or falls within the appropriate range, for each evaluation item indicated in the basic profile. Basic evaluator 131 determines that the target data is “conforming (normal)” when the target data is the appropriate value or falls within the appropriate range and determines that the target data is “non-conforming (anomalous)” in the other case. Note that the result of the data cleansing in the pre-processing (S122) is also subjected to quality evaluation as a noise-related item defined in the basic profile shown in FIG. 5A.

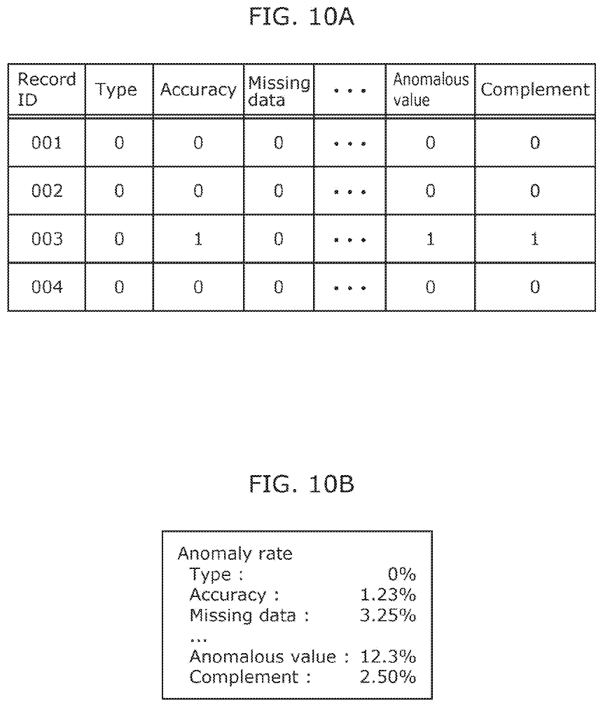

FIG. 10A is a diagram showing check results that are based on the basic profile and obtained for the respective records and evaluation items. As shown in FIG. 10A, a check result is associated with each combination of a record ID and an evaluation item. Check results are represented, for example, by the two values of “0” indicating conformance and “1” indicating non-conformance. Basic evaluator 131 performs statistical processing on the check result of each record, thereby generating an evaluation result for each evaluation item. For example, basic evaluator 131 generates evaluation results as shown in FIG. 10B.

FIG. 10B is a diagram showing quality evaluation results that are based on the basic profile. The quality evaluation results shown in FIG. 10B represent the non-conformance rates (anomaly rates) for the respective evaluation items. An anomaly rate is the proportion of the number of non-conforming (anomalous) records to the total number of records included in learning data.

Returning to FIG. 9, data manager 170 stores, in the memory, the check results shown in FIG. 10A and the evaluation results shown in FIG. 10B as part of the quality evaluation result in the learning phase (S133). Note that the quality evaluation result to be stored may include the evaluation results shown in FIG. 10B, but may not include the check results for the respective records and the respective evaluation items shown in FIG. 10A.

Next, statistics evaluator 132 evaluates each learning data on the basis of the statistics profile (S134). More specifically, statistics evaluator 132 calculates, for each data item, the statistics defined in the statistics profile. In the case of the learning data shown in FIG. 4, for example, statistics evaluator 132 calculates the statistics for each of the numbers of products and the number of defective products.

Next, data manager 170 stores, in the memory, the calculated statistics as part of the quality evaluation result in the learning phase (S135).

### 3-2. Operation Phase

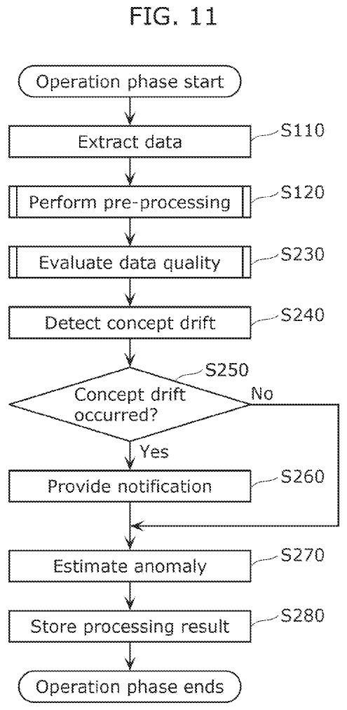

With reference to FIG. 11, the following describes processing performed in the operation phase. FIG. 11 is a flowchart of the processing performed in the operation phase among the processes performed by information processing device 100 according to the present embodiment. The operation phase starts upon receipt of a start instruction from, for example, the manager, or while the manufacturing equipment is in operation.

In the operation phase, as shown in FIG. 11, extractor 110 first extracts a dataset to be subjected to anomaly estimation (S110). For example, extractor 110 extracts, from data storage 101, a plurality of instances of sensor data for a predetermined period such as 1 second, 1 minute, 10 minutes, and 1 hour.

Note that the period of the dataset to be subjected to anomaly estimation is shorter than the period of the dataset for learning, but the present disclosure is not limited to this. Extractor 110 may also obtain sensor data outputted from each sensor provided in the manufacturing equipment. Stated differently, the processing shown in FIG. 11 may be repeated substantially in real-time in line with the manufacture of products.

Next, pre-processor 120 performs the pre-processing on the extracted dataset (S120). The pre-processing is the same as that performed in the learning phase, and is thus performed in two stages as shown in FIG. 8. Data manager 170 stores and manages, in the memory, a plurality of instances of operation data that are data having undergone the pre-processing, as dataset 175.

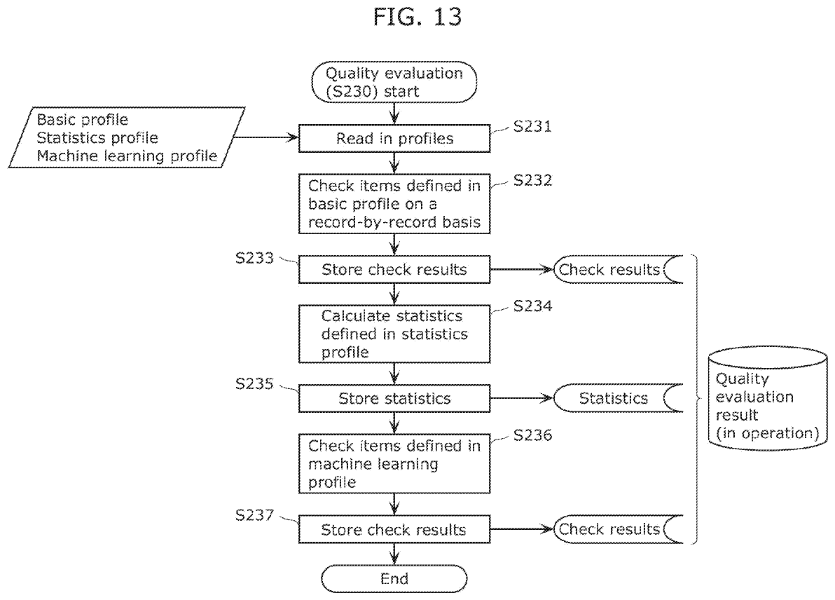

Next, quality evaluator 130 evaluates the quality of each operation data (S230). Data manager 170 stores and manages, in the memory, the result of the quality evaluation as part of quality evaluation results 173. A specific example of the quality evaluation on operation data will be described later with reference to FIG. 13.

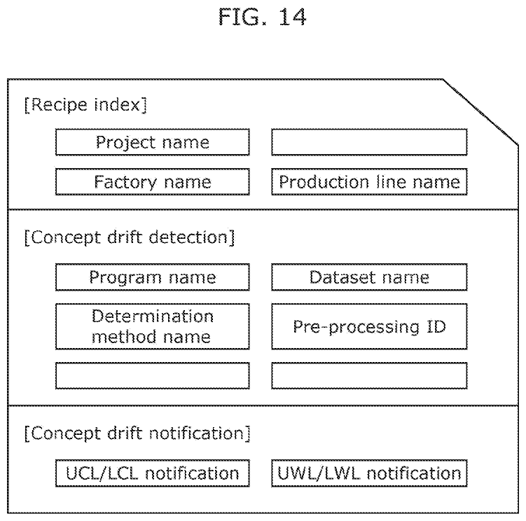

Next, detector 150 detects a concept drift on the basis of quality evaluation results 173 (S240). A specific example of concept drift detection will be described later with reference to FIG. 14 through FIG. 17.

When a concept drift is detected (Yes in S250), notifier 153 provides a notification indicating that a concept drift has been detected (S260).

After the notification is provided or when no concept drift is detected (No in S250), anomaly estimator 160 applies the machine learning model to operation data, thereby estimating an anomaly in the operation data (S270). Anomaly estimator 160 stores the anomaly estimation result in the memory (S280).

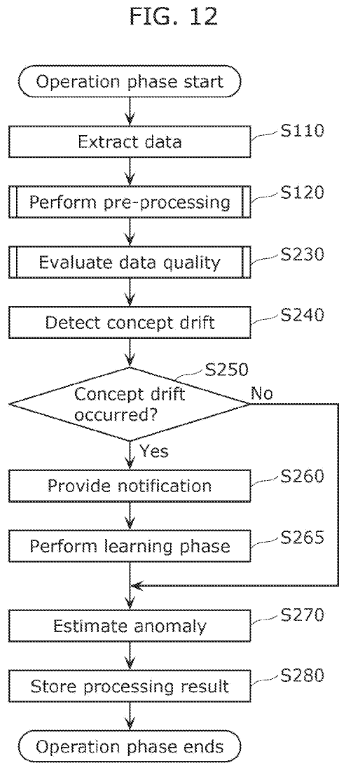

Note that an example is shown in FIG. 11 in which an anomaly estimation is performed regardless of whether a concept drift is detected, but the present disclosure is not limited to this example. When a concept drift is detected, the processing may proceed to the learning phase without performing anomaly estimation as shown in FIG. 12 (S265). In the learning phase, a new machine learning model is generated, using new data as learning data.

With this, it is possible to generate an optimal machine learning model through re-learning, when a concept drift has been detected. By performing anomaly estimation after an optimal machine learning model is generated, it is possible to enhance the reliability of anomaly estimation.

### 3-2-1. Quality Evaluation (Operation Phase)

With reference to FIG. 13, the following describes data quality evaluation. FIG. 13 is a flowchart of a data quality evaluation performed in the operation phase among the processes performed by information processing device 100 according to the present embodiment.

First, as shown in FIG. 13, quality evaluator 130 reads in the basic profile, the statistics profile, and the machine learning profile (S231).

Next, basic evaluator 131 evaluates each operation data on the basis of the basic profile (S232). More specifically, basic evaluator 131 evaluates the operation data for the items defined in the basic profile on a record-by-record basis. The evaluation that is based on the basic profile is the same as the evaluation performed in the learning phase (S132). Next, data manager 170 stores, in the memory, the evaluation results that are based on the basic profile as part of the quality evaluation result in the operation phase (S233).

Next, statistics evaluator 132 evaluates each operation data on the basis of the statistics profile (S234). More specifically, statistics evaluator 132 calculates, for each data item, the statistics defined in the statistics profile. The evaluation that is based on the statistics profile is the same as the evaluation performed in the learning phase (S134). Next, data manager 170 stores, in the memory, the evaluation results that are based on the statistics profile as part of the quality evaluation result in the operation phase (S235).

Next, learning evaluator 133 evaluates each operation data on the basis of the machine learning profile (S236). More specifically, learning evaluator 133 checks the items defined in the machine learning profile.

For example, learning evaluator 133 checks whether the features included in each operation data are the features used for machine learning. In an example shown in FIG. 6, “equipment name”, “element size, and “polymerization specification” are used as features in machine learning. As such, learning evaluator 133 checks whether the operation data includes each of “equipment name”, “element size, and “polymerization specification” and whether the operation data includes features other than these. Also, for example, learning evaluator 133 also calculates the difference between the statistics obtained from the machine learning model (learning statistics) and the statistics obtained on the basis of the operation data, and checks whether the calculated difference falls within a predetermined range.

Data manager 170 stores, in the memory, the check results that are based on the machine learning profile as part of the quality evaluation result in the operation phase (S237).

### 3-2-2. Concept Drift Detection

The following describes concept drift detection.

In the present embodiment, detector 150 detects a concept drift on the basis of a predetermined detection recipe. The detection recipe is a check rule for determining whether a concept drift has occurred.

FIG. 14 is a diagram showing the detection recipe for concept drift detection. The detection recipe shown in FIG. 14 includes three items: recipe index; concept drift detection recipe; and concept drift notification recipe.

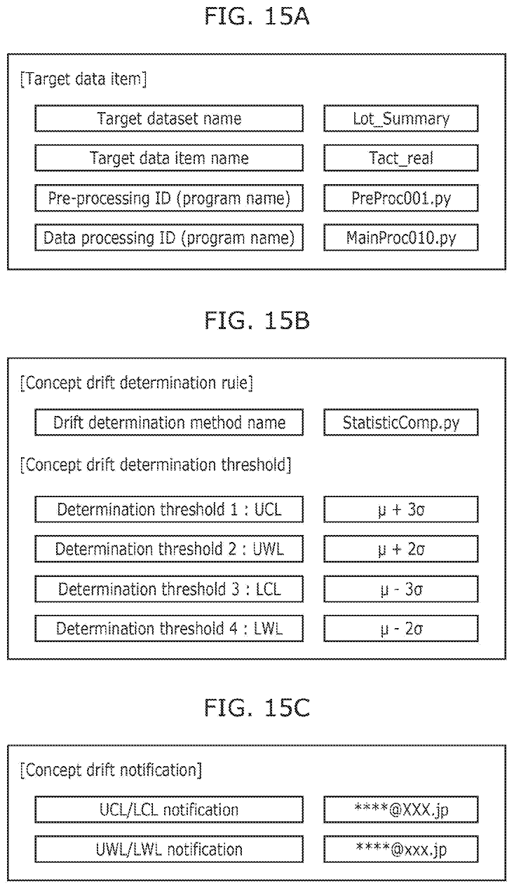

The recipe index includes: an overview of a manufacturing system for which information processing device 100 performs processing; and predetermined index information. More specifically, the recipe index defines the project name, the factory name, the production line name, and so forth. The concept drift detection recipe defines information relating to concept drift detection. More specifically, the concept drift detection recipe defines a program name, a dataset name, a determination method name, a pre-processing ID, and so forth. As shown in FIG. 15A and FIG. 15B, for example, a specific name and a value of each of the defined items are associated with each other.

FIG. 15A is a diagram showing a specific example of the data items in the concept drift detection recipe. In an example shown in FIG. 15A, data items to be checked in the concept drift detection are defined.

FIG. 15B is a diagram showing a specific example of a determination rule in the concept drift detection recipe. In an example shown in FIG. 15B, a rule to be followed in concept drift detection is defined. Stated differently, a rule for determining whether a concept drift has occurred is defined. More specifically, the program name and determination thresholds are defined.

The rule for determining whether a concept drift has occurred includes at least one of the evaluation results of the basic profile, the statistics profile, or the machine learning profile. A concept drift may be determined to have occurred when, for example, the evaluation results on all the evaluation items in the basic profile, the statistics profile, and the machine learning profile satisfy a predetermined condition. Alternatively, a concept drift may be determined to have occurred when simply one of the evaluation results on all the evaluation items in the basic profile, the statistics profile, and the machine learning profile satisfies a predetermined condition. The determination rule may be set as appropriate in accordance with the configuration of a manufacturing system for which information processing device 100 performs processing.

Note that FIG. 14 also shows a recipe relating to concept drift notification. FIG. 15C is a diagram showing the concept drift notification recipe. The notification recipe will be described later.

In the present embodiment, detector 150 selects, for example, a rule defined in the detection recipe and detects a concept drift in accordance with the selected rule. A rule is defined, for example, for each event that can occur in the factory. By defining a rule for each event, it is possible to accurately identify an event that can occur in the manufacturing system.

FIG. 16 is a diagram showing the rules for events that can occur in a factory. As shown in FIG. 16, the quality evaluation results of profile(s) to be used and the behavior of information processing device 100 are associated with each other on an event-by-event basis.

For example, operation data for an event such as the introduction of a new product or the addition of new equipment is less likely to include features used for machine learning. For this reason, by comparing the features used for machine learning and the features included in the operation data on the basis of the machine learning profile, it is possible to detect the occurrence of such event. In this case, it is possible for information processing device 100 to determine that no learning data suited for operation data is present. As such a notification about re-learning will be provided. With this, it is possible to prevent anomaly estimation from being performed using an inappropriate machine learning model, thereby enhancing the reliability of anomaly estimation.

Also, when an event occurs such as a change in the manufacturing process or the manufacturing conditions, a change in the equipment performances caused by, for example, a maintenance work, a change in the factory environment, and a change in the equipment over time, for example, statistics, such as the mean value of sensor data, are more likely to change and have a significant difference from the statistics (learning statistics) obtained from the machine learning model. This is a situation where a concept drift is likely to occur. As such, it is possible to detect a concept drift by calculating the difference between the statistics obtained from the operation data and the learning statistics, on the basis of the statistics profile and the machine learning profile.

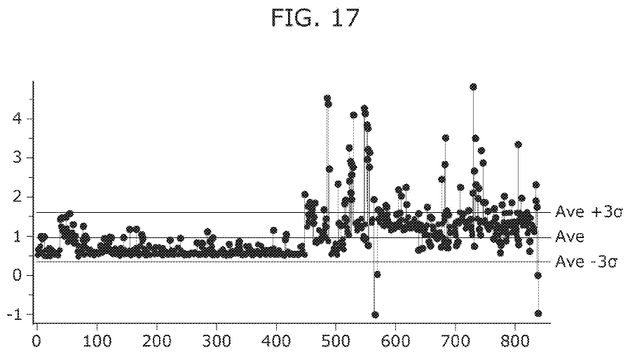

FIG. 17 is a diagram showing sensor data and its statistics. In FIG. 17, the lateral axis indicates time and the vertical axis indicates the numerical values of a predetermined data item. FIG. 17 shows, as statistics, the mean value that is calculated on the basis of learning data and values that are +3σ from such mean value. The range of values that are +3σ from the mean value is a permissible range of values that can be taken. In an example shown in FIG. 17, for example, from around the point at which values in the lateral axis exceed 450, many instances of data do not fall within the permissible range of values that are +3σ from the mean value. For this reason, the use of data in such segment as operation data makes it possible to determine that an anomaly is highly likely to occur or a concept drift is highly likely to be detected.

Also, as shown in FIG. 16, when an event occurs such as an equipment malfunction or trouble, a human error, and a resource-attributable error, for example, many of the data quality evaluation results on learning data and operation data are the same or have a small difference. As such, when a difference is small among the evaluation results that are based on the basic profile, the statistics profile, and the machine learning profile, it is possible to determine that no concept drift has occurred. Stated differently, since the reliability of anomaly estimation is high, it is possible to determine that a notification should be provided about the estimation result of an anomaly, when such anomaly is detected under the condition that no concept drift has occurred.

### 3-2-3. Notification

The following describes a specific example of a notification provided by information processing device 100.

A notification is provided on the basis of the concept drift notification recipe shown in FIG. 14. The concept drift notification recipe defines information relating to the notification of a concept drift.

The concept drift notification recipe may also define information relating to the notification of an anomaly estimation result.

The concept drift notification recipe shown in FIG. 15C defines a rule for notifying a determination result on a concept drift (i.e., detection result). The concept drift notification recipe defines, for example, the destination address of a notification, the details of the notification, and so forth. For example, to a worker in the manufacturing site in the factory, a notification about the occurrence of a concept drift and an anomaly estimation result may be provided, whereas to the manager of information processing device 100, a notification only about the occurrence of a concept drift may be provided.

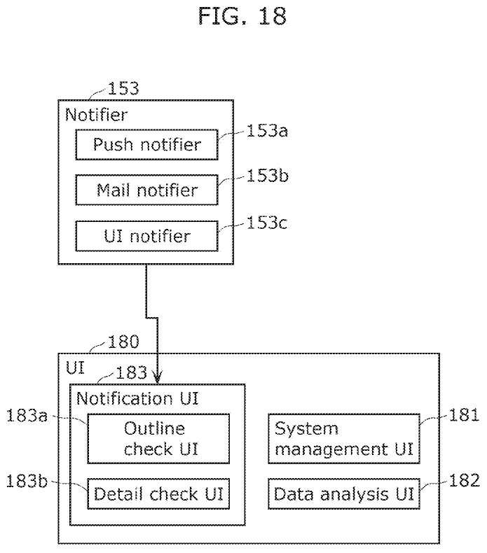

FIG. 18 is a block diagram showing the configuration of notifier 153 and UI 180 of information processing device 100 according to the present embodiment. As shown in FIG. 18, notifier 153 includes push notifier 153a, mail notifier 153b, and UI notifier 153c.

Push notifier 153a provides a push notification to a preliminarily registered destination address. A push notification may include, for example, a simple message indicating that a concept drift has occurred and/or address information used to access a notification

UI to be described later.

Mail notifier 153b sends an e-mail to a preliminarily registered destination address. An e-mail may include, for example, a message indicating that a concept drift has occurred and/or address information used to access the notification UI.

UI notifier 153c provides a notification via UI 180.

Which one of the functions to execute among push notifier 153a, mail notifier 153b, and UI notifier 153c is determined on the basis of the concept drift notification recipe. Note that at least one of push notifier 153a, mail notifier 153b, or UI notifier 153c may provide a notification about an anomaly estimation result.

As shown in FIG. 18, UI 180 includes system management UI 181, data analysis UI 182, and notification UI 183.

System management UI 181 is a UI that relates to the entire processing performed by information processing device 100. System management UI 181 is, for example, a UI for receiving various operations from the manager, etc., such as an operation for starting the learning phase or the operation phase, an operation for switching UI screen displays, and so forth.

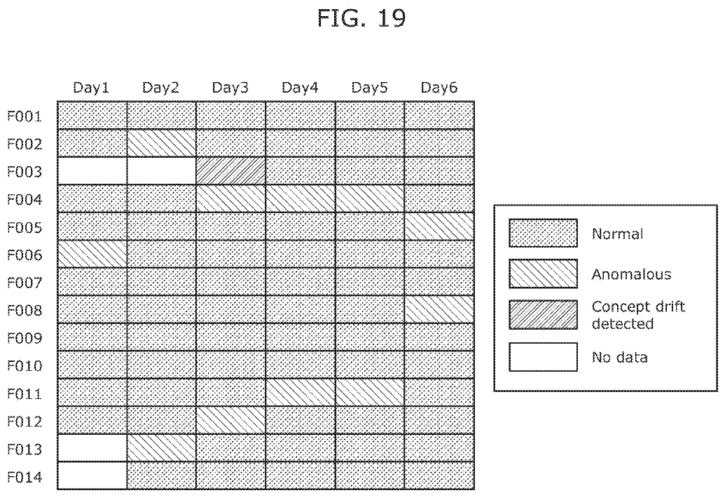

Data analysis UI 182 is a UI that displays a result of data processing performed by information processing device 100. FIG. 19 is a diagram showing data analysis UI 182. Data analysis UI 182 includes anomaly estimation results and concept drift detection results. In an example shown in FIG. 19, the result for each operation data for a predetermined period (here, one day) is shown for each equipment ID such as “F003”. The results are represented in four types: normal, anomalous, concept drift detected, and no data.

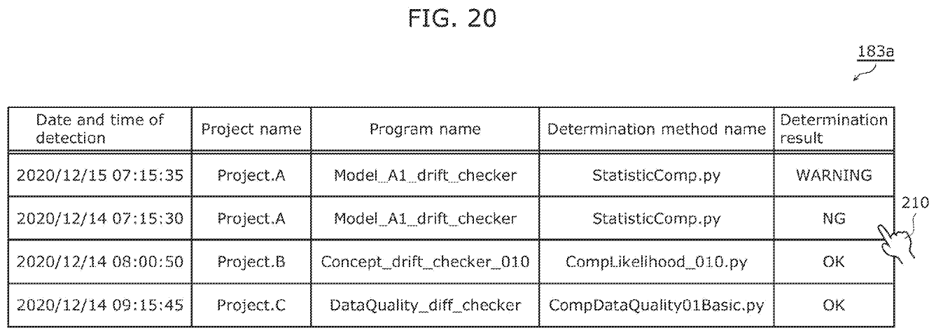

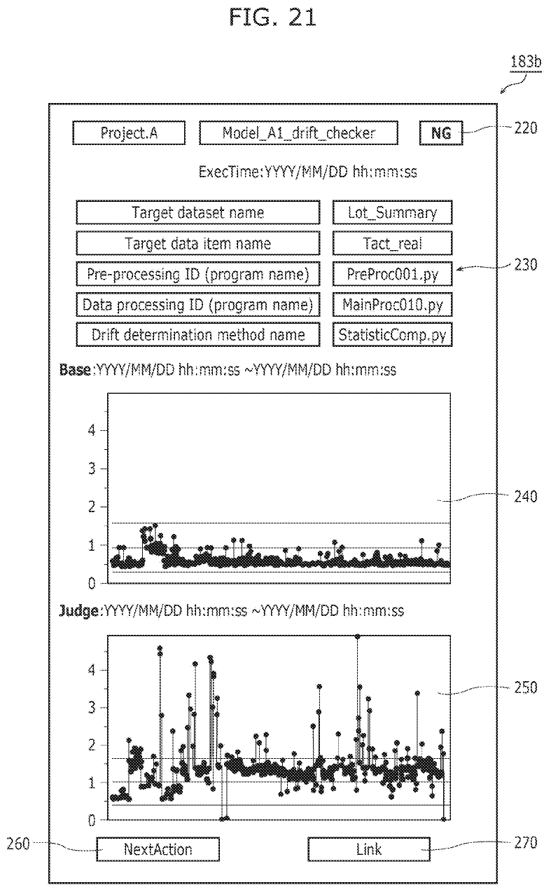

These four types are represented, for example, in different colors or with different shadings to facilitate visual distinction. A cursor (not illustrated) for selecting a region of focus may be displayed in data analysis UI 182. Outline check UI 183a shown in FIG. 20 or detail check UI 183b shown in FIG. 21 may be displayed by operating the cursor to select a region.

FIG. 20 is a diagram showing outline check UI 183a. As shown in FIG. 20, the concept drift detection results are displayed in list form. Outline check UI 183a includes date and time of detection, project name, program name, determination method name, and determination result. Also, cursor 210 is displayed together with outline check UI 183a.

The manager, such as a user, is able to select a detection result by operating cursor 210. With this, detail check UI 183b as shown in FIG. 21, for example, is displayed on the display.

FIG. 21 is a diagram showing detail check UI 183b. Detail check UI 183b includes concept drift detection result 220, determination conditions 230 for the program used for such detection, basic information 240 that is generated in the learning phase and that is subjected to comparison, and target information 250 obtained from operation data.

In an example shown in FIG. 21, each of basic information 240 and target information 250 shows changes over time in values of the same data item. Basic information 240 and target information 250 may show a threshold used for the determination.

Detail check UI 183b also includes selectable GUI buttons 260 and 270. For example, GUI button 260 is the button that shows the next action to be performed. By selecting GUI button 260, it is possible to perform such action. When a concept drift is detected, for example, GUI button 260 for performing re-learning is displayed.

Meanwhile, GUI button 270 is a link button for accessing other related information. By selecting GUI button 270, it is possible to access, for example, a related website.

Note that the UIs shown in FIG. 19 through FIG. 21 are mere examples, and thus the present disclosure is not limited to these examples.

### Other Embodiments

The information processing device, the information processing method, and so forth according to one or more aspects have been described above on the basis of the embodiment, but the present disclosure is not limited to such embodiment. The scope of the present disclosure also includes an embodiment achieved by making various modifications to the embodiment that can be conceived by those skilled in the art and an embodiment achieved by freely combining some of the elements in different embodiments without departing from the essence of the present disclosure. For example, the foregoing embodiment shows an example of using the three profiles of the basic profile, the statistics profile, and the learning profile in quality evaluation, but only one or only two profiles of these may be used. Alternatively, four or more profiles may be used in quality evaluation.

Also, when detector 150 detects a concept drift, for example, anomaly estimator 160 may not apply the machine learning model to operation data. Stated differently, anomaly estimator 160 may apply the machine learning model to operation data only when detector 150 has not detected a concept drift.

Also, the method for inter-device communication described in the foregoing embodiment is not limited to a specific method. When devices wirelessly communicate with each other, example wireless communication methods (communication standards) include near field communication such as ZigBee®, Bluetooth®, and wireless local area network (LAN). Alternatively, a wireless communication method (communication standards) may be communication that is performed via a wide area communication network such as the Internet. Also, devices may perform wired communication instead of wireless communication. More specifically, the wireless communication is, for example, communication utilizing power line communication (PLC) or a wired LAN.

Also, in the foregoing embodiment, a process performed by a specified processing unit may be performed by another processing unit. Also, the processing order of a plurality of processes may also be changed, and a plurality of processes may be performed in parallel.

For example, the processes described in the forgoing embodiment may be performed by a single device (system) in a centralized manner, or by a plurality of devices in a distributed manner. Also, the processor that executes the foregoing program may be a single processor, or may be a plurality of processors. Stated differently, the processes may be performed in a centralized or distributed manner.

All or some of the elements in the foregoing embodiment, such as a controller, may be configured in the form of an exclusive hardware product, or may be realized by executing a software program suitable for the element. Each of the elements may be realized by means of a program executing unit, such as a central processing unit (CPU) and a processor, reading and executing the software program recorded on a recording medium such as an HDD or a semiconductor memory.

Also, each of the elements such as a controller may be configured in the form of one or more electronic circuits. Each of such one or more electronic circuits may be a general-purpose circuit or may be an exclusive circuit.

Such one or more electronic circuits may include, for example, a semiconductor device, an integrated circuit (IC), or a large scale integration (LSI). The IC or LSI may be integrated into a single chip or in a plurality of chips. Although the electronic circuit is referred to here as IC or LSI, it may be referred to differently depending on the degree of integration. The IC or LSI can thus be referred to as a system LSI, a very large scale integration (VLSI), or an ultra large scale integration (ULSI). Also, a field programmable gate array (FPGA) that allows for programming after the manufacture of an LSI can also be used for the same purposes.

Also, general or specific aspects of the present disclosure may be implemented in the form of a system, a device, a method, an integrated circuit, or a computer program. Alternatively, these general or specific aspects of the present disclosure may be implemented in the form of an optical disc that stores such computer program or a non-transitory computer readable recording medium such as an HDD and a semiconductor memory. These general and specific aspects may also be implemented using any combination of systems, devices, methods, integrated circuits, computer programs, or recording mediums.

Also note that the foregoing embodiment allows for various modifications, replacements, additions, omissions, and so forth made thereto within the scope of the claims and its equivalent scope.

### INDUSTRIAL APPLICABILITY

The present disclosure is applicable for use as an information processing device capable of detecting a concept drift in a highly real-time manner with a small amount of computation. Example applications of the present disclosure include an information processing device that performs various processes, such as anomaly estimation in a factory, using machine learning.

1. An information processing device comprising:
an evaluator that evaluates quality of a plurality of instances of first data to generate a first evaluation result and evaluates quality of a plurality of instances of second data to generate a second evaluation result;
a learner that performs machine learning, using the plurality of instances of first data, to generate a machine learning model for detecting an anomaly;
a detector that compares the first evaluation result and the second evaluation result and detects a concept drift, based on a comparison result; and
an estimator that applies the machine learning model to the plurality of instances of second data to estimate an anomaly in the plurality of instances of second data.

2. The information processing device according to claim 1,
wherein the evaluator includes a basic evaluator that evaluates each of the plurality of instances of first data and each of the plurality of instances of second data, based on a first profile whose evaluation item is at least one of a data type, a character code, or an anomalous value,
the first evaluation result includes an evaluation result on each of the plurality of instances of first data, the evaluation result being based on the first profile, and
the second evaluation result includes an evaluation result on each of the plurality of instances of second data, the evaluation result being based on the first profile.

3. The information processing device according to claim 1,
wherein the evaluator includes a statistics evaluator that evaluates statistics of the plurality of instances of first data and statistics of the plurality of instances of second data, based on a second profile whose evaluation item is at least one statistic,
the first evaluation result includes an evaluation result on each of the plurality of instances of first data, the evaluation result being based on the second profile, and
the second evaluation result includes an evaluation result on each of the plurality of instances of second data, the evaluation result being based on the second profile.

4. The information processing device according to claim 1,
wherein the evaluator includes a learning evaluator that evaluates the plurality of instances of second data, based on a third profile whose evaluation item is at least one feature in the machine learning, and
the second evaluation result includes an evaluation result on each of the plurality of instances of second data, the evaluation result being based on the third profile.

5. The information processing device according to claim 1, further comprising:
an obtainer that obtains a plurality of instances of data; and
a pre-processor that performs pre-processing on the plurality of instances of data to generate the plurality of instances of first data and the plurality of instances of second data.

6. The information processing device according to claim 5,
wherein the pre-processing includes data cleansing and at least one of data coupling or data conversion.

7. The information processing device according to claim 1, further comprising:
a notifier that provides a notification indicating that a concept drift has been detected, when the detector detects the concept drift.

8. The information processing device according to claim 1,
wherein when the detector detects a concept drift, the learner performs machine learning, using a plurality of instances of data that are different from the plurality of instances of first data, to generate the machine learning model anew.

9. An information processing method comprising:
evaluating quality of a plurality of instances of first data to generate a first evaluation result;
performing machine learning, using the plurality of instances of first data, to generate a machine learning model for detecting an anomaly;
evaluating quality of a plurality of instances of second data to generate a second evaluation result;
comparing the first evaluation result and the second evaluation result and detecting a concept drift, based on a comparison result; and
applying the machine learning model to the plurality of instances of second data to estimate whether an anomaly is present in the plurality of instances of second data.

10. A non-transitory computer-readable recording medium having recorded thereon a program for causing a computer to execute the information processing method according to claim 9.
